(19) United States
(12) Patent Application Publication
(10) Pub. No.: US 2010/0302382 A1
(43) Pub. Date: Dec. 2, 2010

(54) IMAGE DATA PROCESSING APPARATUS, AND RECORDING MEDIUM ON WHICH AN IMAGE DATA PROCESSING PROGRAM IS RECORDED

(75) Inventors: Takashi Oikawa, Toyohashi-shi (JP); Shinichi Asai, Gamagoori-shi (JP); Tomokazu Kato, Toyokawa-shi (JP); Hiroshi Iwamoto, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/792,106

(22) Filed: Jun. 2, 2010

(30) Foreign Application Priority Data
Jun. 2, 2009 (JP) 2009-133246

(51) Int. Cl. H04N 5/225; G06F 3/12

(52) U.S. Cl. 348/207.2; 358/1.15; 348/E05.024

(57) ABSTRACT

The present invention provides an image data processing apparatus that is capable of selecting and processing particular images from among a large number of images, based on the user's actions relating to the images. An MFP 4 acquires a file information list from an imaging apparatus 2 (S3), acquires a schedule containing a date and time, a location, and so on of an action of an employee from an employee management server 3 (S5), and searches for file information sets that contain the date and time or the location corresponding to the date and time or the location indicated by the schedule (S7, S8). When any file information sets are found by the search (S7: YES, S8: YES), the image data processing apparatus acquires image data sets relating to the file information sets found by the search, and performs processing, such as printing, of the image data sets (S9).

This application is based on an application No. 2009-133246 filed in Japan, the contents of which are hereby incorporated by reference.

### BACKGROUND OF THE INVENTION

(1) Field of the Invention

The present invention relates to an image data processing apparatus for performing processing, such as printing, of a large number of image data sets, and particularly to a technology to narrow down the target of the processing.

(2) Description of the Related Art

Generally, image data sets relating to images that are captured with a digital camera are each recorded on a recording medium, such as a built-in memory and a memory card, together with an attribute information set attached to the image data set. Each attribute information set includes a shooting date and time and a file name. Today's recording media have a large capacity, and meanwhile, it is easy to delete already recorded files. This allows the user of a digital camera to shoot a large number of images one after another. As a result, a large number of files would be stored on the recording medium. In addition, many recent digital cameras have a movie recording function. Thus, there is a possibility that a large number of image files and a large number of movie files coexist on the recording medium. In such a case, when the user wishes to print out some of the image files, the user is required to select them based on their file names and so on. This is troublesome for the user.

As a technology to select the processing target files from among a large number of files, Patent Literature 1 (Japanese Patent Application Publication No. 11-321029) discloses a technology to judge whether any printable image files are on a recording medium based on extensions of the files recorded on the recording medium, and to print the printable image files after performing image expansion processing on them. This saves the user the trouble of selecting files that have a particular extension, from among a large number of files.

### Problems to be Solved by the Invention

However, with the technology disclosed in the Patent Literature 1, the user is only able to narrow down the large number of files to processing target files that have a particular extension. That is, it is impossible for the user to further narrow down the processing target files to those captured during a particular action of the user, such as attendance at a meeting.

For example, suppose a case where the user uses a company-owned digital camera for both business and private purposes. In such a case, images captured for the business purpose and images captured for the private purposes coexist on the recording medium. To narrow down the target of the processing (e.g. printing) to the images captured for the business purpose, the user has to check the shooting date and time and so on for each of the large number of image files relating to the business. Furthermore, if meetings are held over several days and images relating to the private use are captured in the periods between the meetings, the shooting dates of the images relating to the meetings are alternate with the shooting dates of the images relating to the private use. This makes the search complicate, and causes more trouble for the user.

### SUMMARY OF THE INVENTION

In view of the problem above, the present invention aims to provide an image data processing apparatus capable of selecting image files relating to a particular action of the user from a large number of image files, and processing the selected image files.

### Means for Solving the Problems

To achieve the aim, one aspect of the present invention provides an image data processing apparatus comprising: a first acquiring unit operable to acquire a schedule of a user; a second acquiring unit operable to acquire attributes of images from an external apparatus, the external apparatus storing therein the images and the attributes, each attribute showing a shooting condition of the corresponding image; an extracting unit operable to compare each attribute with the schedule, and extract attributes that relate to the schedule, according to the result of the comparison; a reading unit operable to read, from the external apparatus, images corresponding to the extracted attributes; and a printing unit operable to print the read images.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the structure of an image data processing system 1 according to an embodiment of the present invention;

FIG. 2 shows an example of a file information list;

FIG. 3 shows an example of a schedule data base pertaining to Employee A, which is stored in an employee management server 3;

FIG. 4 is a block diagram showing the structure of an MFP 4;

FIG. 5 is a flowchart showing printing processing performed by the image data processing system 1;

FIG. 6 shows a schedule shown on a display;

FIG. 7 is a flowchart showing image data processing;

FIG. 8 is the result of image data printing performed after addition of file information; and

FIG. 9 is a cross sectional view schematically showing an overall structure of the MFP 4.

### DESCRIPTION OF THE PREFERRED EMBODIMENTS

### 1. First Embodiment

An image data processing system 1 pertaining to an embodiment of the present invention is capable of selecting images captured for a business purpose from among images captured with an imaging apparatus such as a digital camera, and allowing processing, such as printing, of the selected images, but restricting the processing of images captured for a private purpose.

### 1.1 Structure

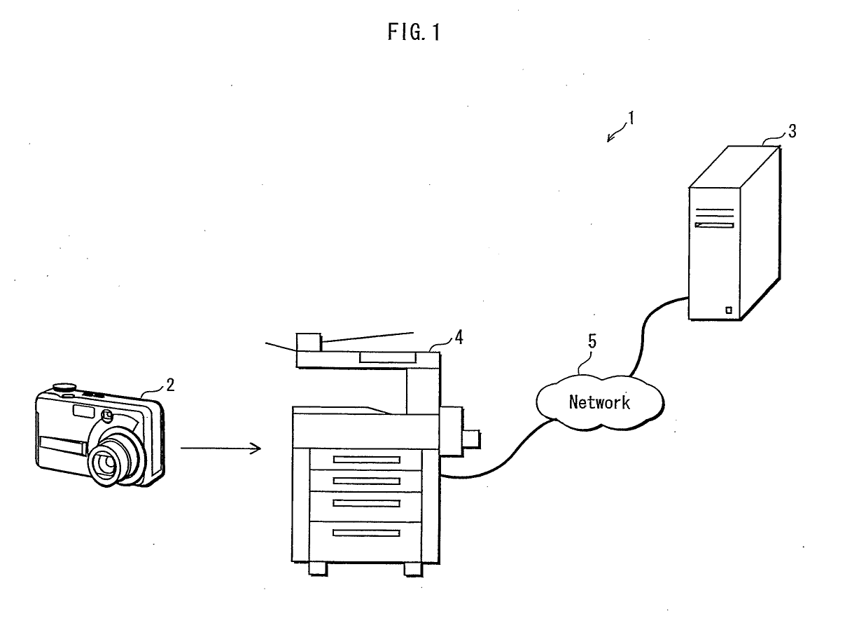

FIG. 1 shows the structure of the image data processing system 1 pertaining to an embodiment of the present invention.

The image data processing system 1 includes an MFP (Multi Function Peripheral) 4, an imaging apparatus 2 connecting the MFP 4 via USB, and an employee management server 3 communicating with the MFP 4 via a network 5.

The network 5 is structured from the Internet, dedicated lines, and so on.

The imaging apparatus 2 is a digital camera having a GPS (Global Positioning System) function. When shooting an image, the imaging apparatus 2 acquires the location (i.e. the latitude and the longitude) where the imaging apparatus 2 captures the image, by using the GPS function. Then, the imaging apparatus 2 generates attribute information for the captured image, and adds the attribute information to the image data of the captured image. The attribute information includes the file name of the image data, the shooting date and time of the image, and the location. Hereinafter, the attribute information set is called “file information set”. The image data with the file information set attached thereto is managed as a single data file. The image apparatus 2 stores the file onto a recording medium such as a built-in memory and a memory card (hereinafter simply called a memory). In this embodiment, it is assumed that each file name includes a sequential number that is given in the order of the shooting (e.g. image01, image02, and so on).

Upon receipt of a request from the MFP 4, the imaging apparatus 2 generates a list of the file information sets (hereinafter called “file information list”) relating to the files recorded on the memory of the imaging apparatus 2, and transmits the file to the MFP 4. The file information list does not contain image data, and thus the size of the list is generally several kilobytes or less.

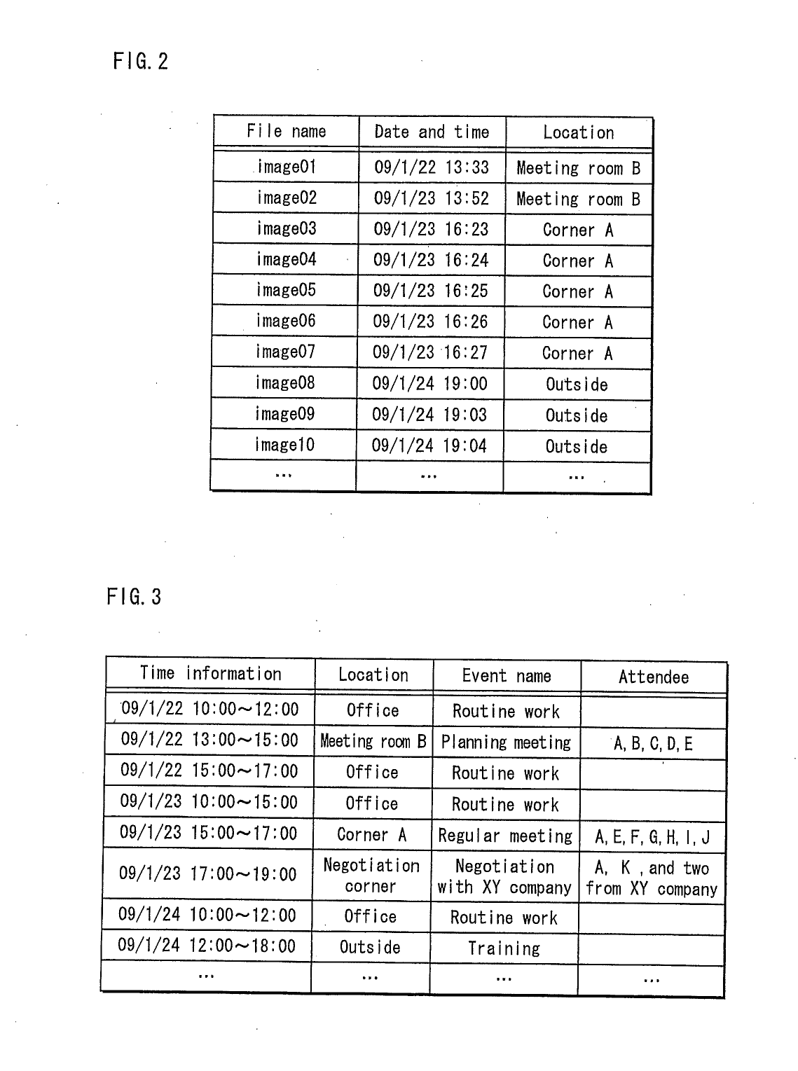

FIG. 2 shows an example of the file information list.

For example, the first one of the file information sets included in the file information list shows the following: a file having a file name “image 01” is stored on the built-in memory of the imaging apparatus 2; and the file contains an image data captured in Meeting room B at 13:33 on Jan. 22, 2009. In FIG. 2, the location is simply shown as “Meeting room B”. However, as mentioned above, the location actually is information indicating the latitude and the longitude of Meeting room B. In this embodiment, it is assumed that Employee A is using the imaging apparatus 2.

The employee management server 3 is a server apparatus for managing schedules of the employees in cooperation with other systems relating to the schedules, namely a destination management system, an attendance management system, and an access management system for example (not illustrated). The destination management system manages business destinations of the employees. The attendance management system manages workplace attendance of the employees. The access management system manages access to rooms in the company. For the schedule management, the employee management server 3 acquires information from the other systems, and generates and stores therein a schedule database (hereinafter called schedule DB), which shows each employee's schedule.

FIG. 3 shows an example of the schedule DB stored in the employee management server 3. This example shows a schedule relating to Employee A.

The schedule DB is a list of event information sets, each including time information, a location, an event name, and attendees' information or information of the teammembers making the event. For example, the first one of the event information sets included in the schedule DB shows that Employee A conducts a routine work in the office from 10:00 to 12:00 on Jan. 22, 2009. The second one of the event information sets included in the schedule DB shows that Employee A attends a planning meeting in Meeting room B from 13:00 to 15:00 on Jan. 22, 2009 and Employees A, B, C, D and E are the attendees of the meeting.

The employee management server 3 receives, from the MFP 4, a schedule request with parameters indicating the employee to be searched and time information relevant to the search. The employee management server 3 extracts event information sets matching the time information in the parameters, and sends a list of the extracted event information sets, as a schedule of the relevant employee, to the MFP 4.

The MFP 4 acquires the file information list from the imaging apparatus 2 and the schedule from the employee management server 3. Using the acquired file information list and schedule, the MFP 4 selects image files satisfying a given condition (e.g. image files relating to the business), and performs processing, such as printing, on the selected files.

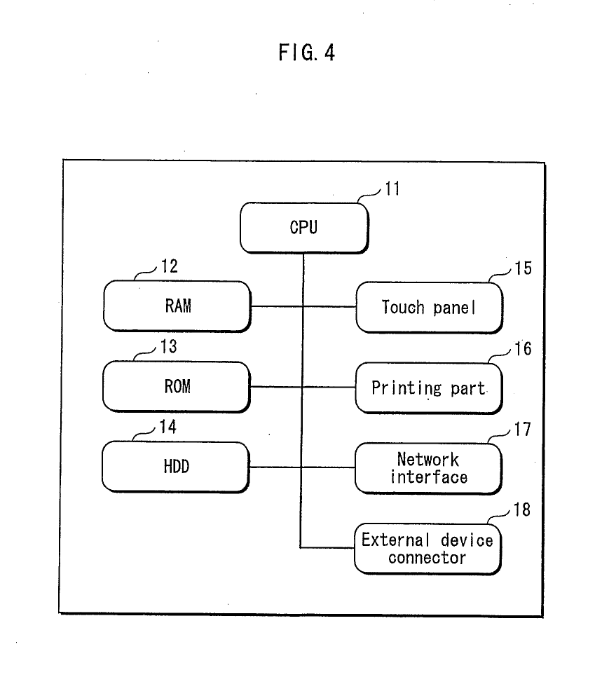

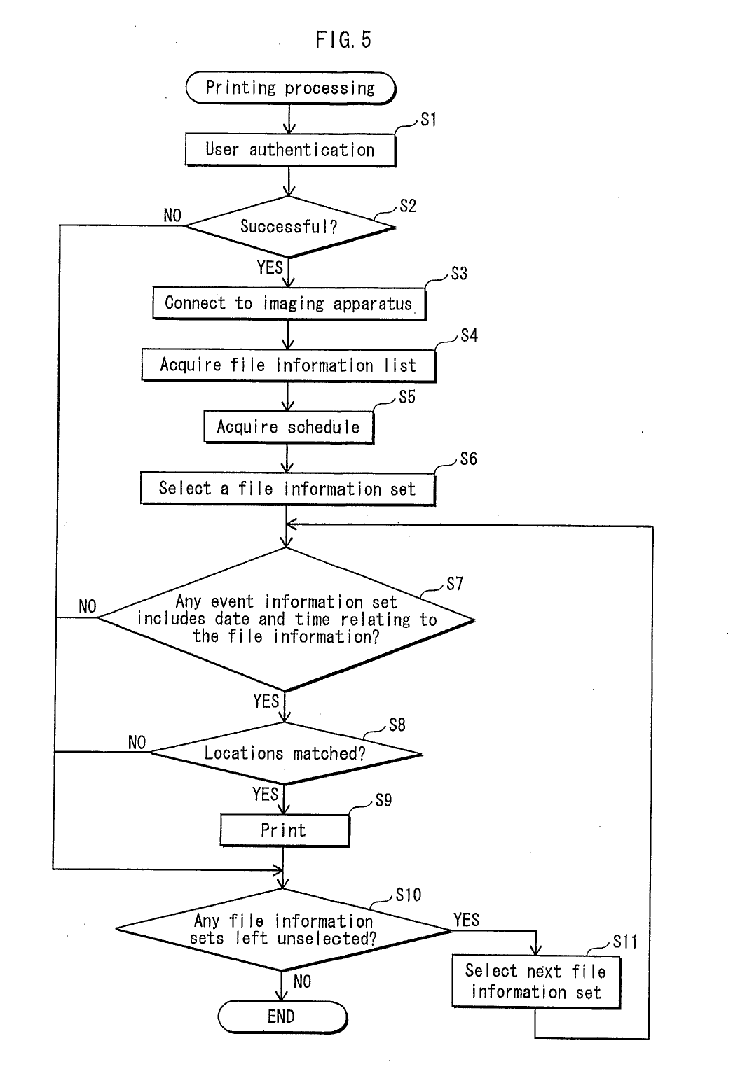

FIG. 4 is a block diagram showing the structure of the MFP 4.

As shown in FIG. 4, the MFP 4 includes a CPU (Central Processing Unit) 11, a RAM (Random Access Memory) 12, a ROM (Read Only Memory) 13, an HDD 14, a touch panel 15, a printing part 16, a network interface 17, and an external device connector 18.

The CPU 11 is a processor for reading programs stored in the ROM 13 into the RAM 12 and executes them. The CPU 11 controls the whole MFP 4, generation of a GUI (Graphical User Interface) to be displayed on the touch panel 15, and display of the GUI.

The ROM 13 is a non-volatile memory, and stores therein programs for operating the CPU 11, such as an OS (Operating System), an authentication program, and application programs such as an image display program.

In the following explanation, programs are sometimes described as if they act by themselves. For example: “The image display program displays a GUI (Graphical User Interface) on the touch panel 15”. However, this is for simplification of the explanation. It actually means: “The CPU 11 executes the image display program, a GUI is generated by the operation of the image display program, and the CPU 11 displays the generated GUI on the touch panel 15”.

The image display program generates a GUI and so on to be displayed on the touch panel 15, and includes a rendering engine and so on. The rendering engine is a module for performing image processing such as scaling of an image, extraction of a part from an image, and combining of images.

The HDD 14 is a large-capacity storage device for storing data such as image data acquired from the imaging apparatus 2.

The touch panel 15 includes a touch panel part which is touch sensitive and an LCD part. The touch panel part acquires the coordinates of the position touched by the user, and notifies the image display program of it. The image display program compares the coordinates with the GUI being displayed on the touch panel part, and identifies the user instruction. The image display program notifies, of the identified instruction, other programs and processing units that relate to the instruction. One example of such processing units is the printing part 16.

The printing part 16 is a printer for printing image data and so on.

The network interface 17 communicates with the employee management server 3 via the network 5.

The external device connector 18 connects to the imaging apparatus 2 via USB, and acquires a file information list, files, and so on, from the imaging apparatus 2.

Regarding the structure of the MFP 4, the following gives an additional explanation mainly about the printing part 16.

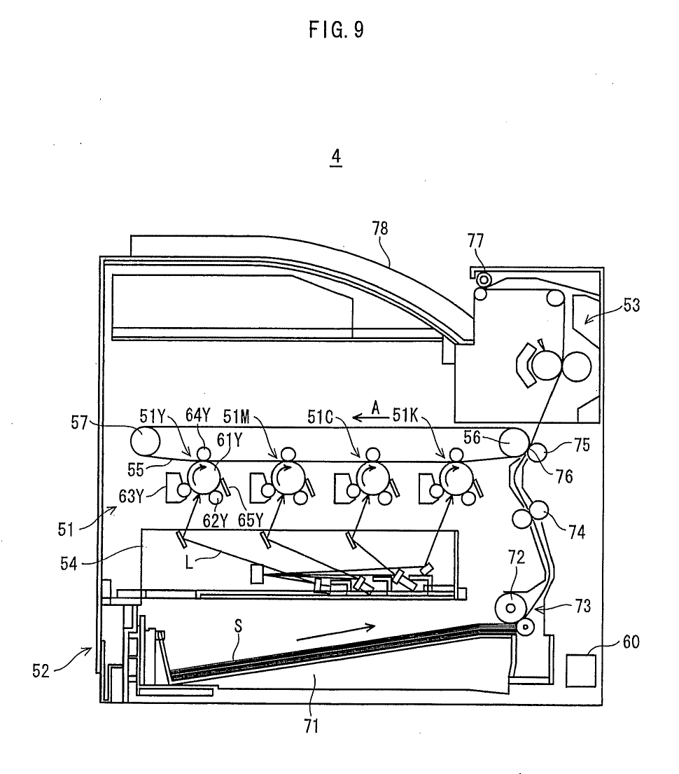

FIG. 9 is a cross sectional view schematically showing the overall structure of the MFP 4.

As shown in FIG. 9, the MFP 4 includes an image processor 51, a paper feeder 52, a fixing part 53 and a controller 60.

The image processor 51, the paper feeder 52 and the fixing part 53 correspond to the printing part 16 shown in FIG. 4. The controller 60 corresponds to the CPU 11, the RAM 12, the ROM 13 and the HDD 14 shown in FIG. 4. The touch panel 15, the network interface 17, and the external device connector 18 are not illustrated in FIG. 9.

Upon receipt of a printing instruction from the controller 60, the MFP 4 generates a toner image composed of yellow, magenta, cyan and black colors according to the instruction, and forms a full-color image by performing multilayer transfer. In the following description, the yellow, magenta, cyan and black reproduction colors will be represented as Y, M, C and K, respectively. Also, the letters Y, M, C, and K are appended to reference numbers of components relating to the reproduction colors.

The image processor 51 includes image formers 51Y, 51M, 51C and 51K, an optical unit 54, an intermediate transfer belt 55, and so on.

The image former 51Y includes a photosensitive drum 61Y, a charger 62Y, a developer 63Y, a primary transfer roller 64Y, a cleaner 65Y, and so on. The charger 62Y is positioned surrounding the photosensitive drum 61Y. The cleaner 65Y is for cleaning the photosensitive drum 61Y. The image former 51Y forms a color Y toner image on the photosensitive drum 61Y. Note that the image formers 51M to 51K have similar structures to the image former 51Y. The reference numbers of the components of the image formers 51M to 51K are omitted in FIG. 9.

The intermediate transfer belt 55 is an endless belt suspended in a tensioned state on a driving roller 56 and a driven roller 57, and is driven and rotated in the direction of arrow A.

The optical unit 54 includes luminous elements such as laser diodes. With a drive signal transmitted from the controller 60, the optical unit 54 performs exposure scanning of the photosensitive drums 51Y to 51K by emitting laser beams L for forming images in the colors Y to K.

This exposure scanning forms electrostatic latent images on the photosensitive drums 61Y to 61K that have been charged by the chargers 62Y to 62K. The electrostatic latent images are developed by the developers 63Y to 63K. The toner images of the colors Y to K, which have been formed on the photosensitive drums 61Y to 61K, are primary-transferred on the intermediate transfer belt 55 at different timings, so that the toner images of colors Y to K are layered on the intermediate transfer belt 55 in the same position.

The toner images of the colors Y to K are sequentially transferred to the intermediate transfer belt 55 by electrostatic power acting on primary transfer rollers 64Y to 64K. These toner images as a whole constitute a full-color toner image. These toner images are then carried to a secondary transfer position 76.

The paper feeder 52 includes a paper feed cassette 71, a pickup roller 72, a pair of timing rollers 74, and so on. The paper feed cassette 71 contains a sheet S. The pickup roller 72 picks up the sheet S of the paper feed cassette 71 and directs the sheet S onto a conveyance path 73, one sheet at a time. The pair of timing rollers 74 is for adjusting a timing to convey the picked sheet S to the secondary transfer position. The sheet S is conveyed from the paper feeder 52 to the secondary transfer position, in accordance with a timing at which the toner images are conveyed on the intermediate transfer belt 55. The toner images on the intermediate transfer belt 55 are collectively secondary-transferred to the sheet S by a secondary transfer roller 75.

After passing the secondary transfer position 76, the sheet S is conveyed to the fixing part 53. Once the toner images formed on the sheet S (i.e. unfixed images) are fixed onto the sheet S in the fixing part 53 by application of heat and pressure, the sheet S is discharged to a discharge tray 78 via a pair of discharge rollers 77.

### 1.2 Operations

The following describes the operations of the image data processing system 1, with reference to FIG. 5.

The MFP 4 firstly performs user authentication (Step S1).

Specifically, Employee A enters his/her password from a software keyboard or the like displayed on the touch panel 15 of the MFP 4.

The HDD 14 in the MFP 4 prestores the password of Employee A. The authentication program judges whether the password stored in the HDD 14 matches the password entered by Employee A (Step S2). In the case where they mismatch (Step S2: NO), the processing finishes. In the case where they match (Step S2: YES), the authentication program notifies the image display program of the success in the authentication of Employee A, and the image display program displays a message on the touch panel 15 to prompt Employee A to connect the imaging apparatus 2 to the MFP 4.

Employee A connects the imaging apparatus 2 to the external device connector 18 of the imaging apparatus 2 via USB (Step S3). Upon detecting the connection to the imaging apparatus 2, the external device connector 18 notifies the image display program of the connection.

The image display program requests, via the external device connector 18, the imaging apparatus 2 to send a file information list (Step S4). Upon receipt of the request for a file information list, the image apparatus 2 generates a file information list and sends it to the MFP 4.

The image display program in the MFP 4 receives the file information list via the external device connector 18.

The image display program then sends a schedule request with parameters to the employee management server 3 via the network interface 17 (Step S5). One of the parameters indicates Employee A, who has been authenticated in Step S1.

Upon receipt of the schedule request, the employee management server 3 generates a schedule according to the parameters relating to the schedule request, and sends the schedule to the MFP 4.

In this example, the employee management server 3 generates the schedule from the event information sets relating to Employee A. Here, it is assumed that when the parameters received together with the schedule request does not include time information indicating a specific date and time, the employee management server 3 generates the schedule based on a predetermined condition, and sends it to the MFP 4. For example, the employee management server 3 may generate the schedule from all the event information sets, or from the event information sets within a week from the current date and time.

The image display program in the MFP 4 receives the schedule, via the network interface 17.

The image display program selects and reads the file information sets contained in the file information list one bye one (Step S6).

After that, the image display program searches the schedule for event information sets whose time information indicates a period including the date and time indicated by the read file information set (Step S7). If no event is found by the search (Step S7: NO), the processing moves to Step S10, which is descried below. If any events are found by the search (Step S7: YES), the processing moves to Step S8.

For example, when the read file information set relates to “image01”, the date and time of the file information set is “09/1/22 13:33”.

In the case of the schedule shown in FIG. 3, the time information of the second one of the event information sets included in this schedule is “09/1/22 13:00-15:00”, which includes “09/1/22 13:33”. Thus, if this is the case, the image display program finds this event information set as a result of the search.

Next, in Step S8, the image display program judges whether the location relating to the event information set found by the search in Step S7 matches the location indicated by the read file information set. In the case where they mismatch (Step S8: NO), the processing moves to Step S10. In the case where they match (Step S8: YES), the image display program acquires the image data relating to the file information set from the imaging apparatus 2, and causes the printing part 16 to print it (Step S9).

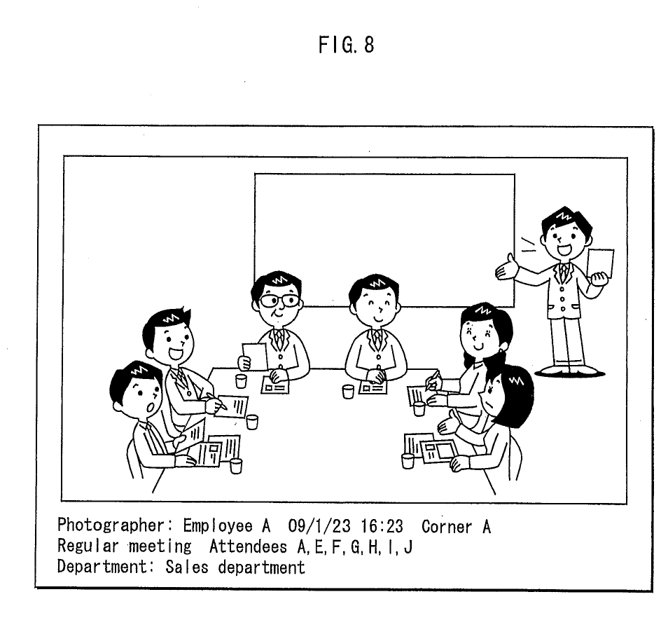

Here, as shown in FIG. 8, the image display program may cause the printing part 16 to print other information acquirable from the event information set, as well as the image. For example, an identification of the photographer, the shooting date and time, the location, the event name, and so on may be printed together with the image. In addition, the image display program may acquire information that is irrelevant to the event information but acquirable by the MFP 4 from the employee management server 3, and cause the printing part 16 to print it together. An example of such information is an identification of the department that the Employee A belongs to.

FIG. 8 shows an example of printing the following in addition to the image: the photographer “Employee A”, who was authenticated as the user; the shooting date and time “09/1/23 16:23”, which relates to the date and time of the file information set; the location “corner A”, where the image was captured; the event name “Regular meeting”; the attendees “A, E, F, G, H, I and J”; and the department “Sales department”, which the Employee A belongs to.

In Step S10, if the file information list contains any file information set that has not been selected (Step S10: YES), the processing returns to Step S7. If all the file information sets have been selected (Step S10: NO), the processing finishes.

As described above, the MFP 4 performs printing of only images of the files corresponding to, for example, event information sets that are under the control of the employee management server 3. That is, the MFP 4 is capable of preventing printing of images that were not captured within the periods and the locations that are under the control of the employee management server 3.

### 2. Second Embodiment

According to the first embodiment, the MFP 4 compares the file information list acquired from the imaging apparatus 2 with the schedule acquired from the employee management server 3, and all the images corresponding to the event information sets contained in the schedule are subject to the processing such as printing.

According to the second embodiment on the other hand, the MFP 4 displays the event information sets contained in the acquired schedule, in the form of a GUI, on the touch panel 15. The user selects desired event information sets from the event information sets displayed as the GUI. The MFP 4 reads only images corresponding to the selected event information sets from the imaging apparatus 2, and performs processing such as printing only on the read images. As a result, when the user wishes to print only images corresponding to desired event information sets, it is unnecessary for the user to take a long time to check all the files in the imaging apparatus 2 one by one and manually selects the images relating to the desired event information sets. What the user is required to do is to simply select desired event information sets from the schedule displayed in the form of a GUI. This operation causes the MET 4 to read the images relating to the desired event information sets from the imaging apparatus 2 and perform processing such as printing on the read images.

The structure of the second embodiment is similar to the first embodiment. The first embodiment and the second embodiment are different only in the operations of the image display program and the GUI to be displayed on the touch panel 15.

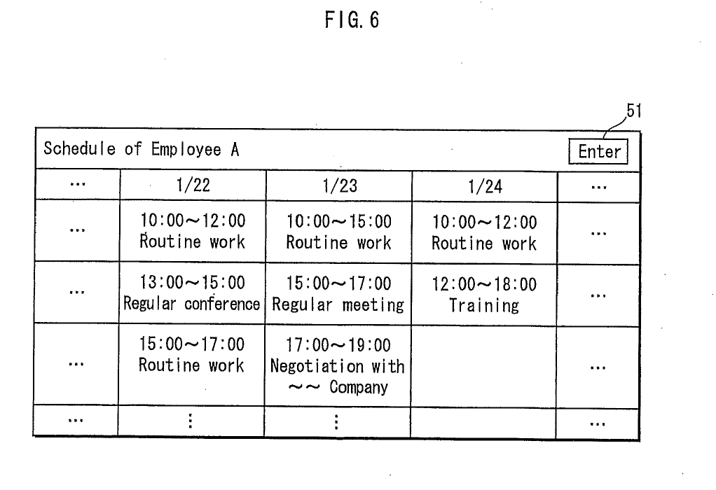

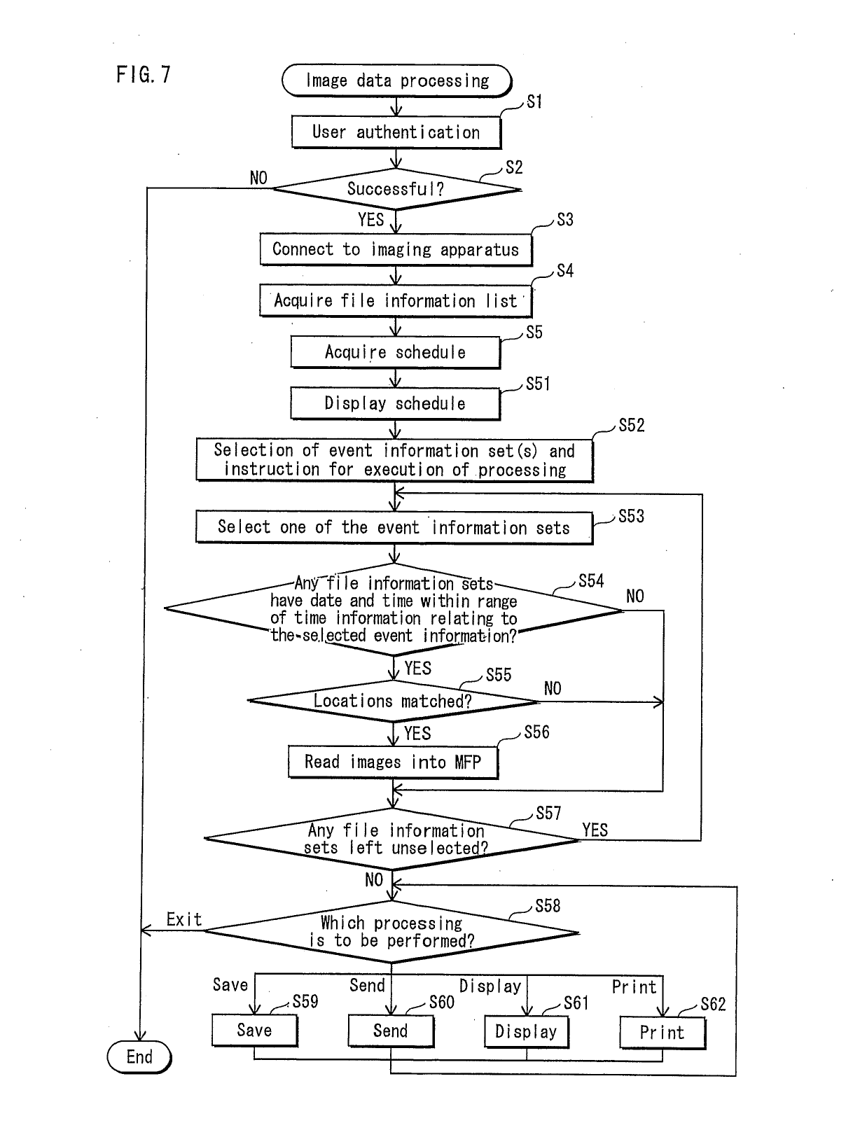

The following explains the operations of the image data processing system 1 pertaining to the second embodiment, with reference to FIG. 6 and FIG. 7. The explanation mainly focuses on the differences from the first embodiment.

Steps S1 to S5 in FIG. 7 are the same as Steps S1 to S5 in FIG. 5.

The image display program in the MFP 4 generates a GUI and displays it on the touch panel 15 as shown in FIG. 6 (Step S51). This GUI shows the event information sets relating to the acquired schedule.

Employee A selects a desired one from among the displayed event information sets by touching it on the touch panel 15, and then instructs execution of processing by touching an enter button 21, which is shown in FIG. 6 (Step S52).

For example, Employee A selects the event information set “15:00˜17:00 Regular meeting” listed in the column for January 23, and touches the enter button 21. Note that Employee A may select two or more event information sets in Step S52 and then touch the enter button 21.

The image display program selects one of the event information sets selected in Step S52 (Step S53).

The MFP 4 searches the file information list for file information sets whose date and time is within the range of the time information indicated by the event information set selected by the image display program (Step S54). In no file information set is found by the search (Step S54: NO), the processing moves to Step S57, which is described below.

If any file information sets are found by the search (Step S54: YES), the MFP 4 judges, for each file information set, whether the location indicated by the file information set matches the location indicated by the event information set.

In the case where they mismatch (Step S55: NO), the processing moves to Step S57. In the case where they match (Step S55: YES), the MFP 4 reads images relating to the file information set from the imaging apparatus 2 (Step S56). For example, suppose the case where Employee A has touched, in Step S52, the item “15:00-17:00 Regular meeting” in the column for January 23 of the GUI displayed on the touch panel 15. If this is the case, in Steps S54 and S55, the file information sets having the file names “image03”, “image04”, “image05”, “image06” and “image07” are found by the search among the file information sets shown in FIG. 2, because each of these file information sets has date and time within the period indicated by the time information of the selected event information set.

Next, in Step S52, the MFP 4 judges whether any of the event information sets selected in Step S52 is left unselected in Step S53 (Step S57). If there is any unselected event information set (Step S57: YES), the processing moves to Step S57. If there is no unselected event information set (Step S57: NO), the image display program displays GUI buttons, namely “Save”, “Send”, “Display”, “Print” and “Exit”, on the touch panel 15. These buttons prompt the user to determine how to process the image read into the MFP 4. Employee A touches one of the buttons “Save”, “Send”, “Display”, “Print” and “Exit” displayed on the touch panel 15 to notify the image display program of the processing to be performed (Step S58).

In the description above, it is the user that determines how to process the image. However, the present invention is not limited to this. For example, how to process the image may be preset in the MFP 4. Alternatively, conditions for switching between processing methods may be predetermined, and the MFP 4 may select a processing method for each image, according to the conditions.

In Step S58, when the user selects “Save” (Step S58: Save), the MFP 4 creates a folder for each event information set in the HDD 14, and stores each of the files relating to the event information sets into the corresponding folder (Step S59). Here, the folder name is generated by using the event name, time information, and location of the event information set. After completing the saving, the processing moves to Step S58.

In Step S58, when the user selects “Send” (Step S58: Send), the MFP 4 sends the image read in Step S56 to an address relating to the image (Step S60). Addresses may be predetermined or be previously associated with the event information sets contained in the schedule. For example, it may be assumed that if an image is captured in a meeting, the image is to be transmitted to the attendees indicated by the attendees' information. Also, in the case the event is a team meeting, the image may be transmitted to the addresses of the team members or the address of the supervisor of the team members acquired from a server. This improves the convenience. Images are sent via fax, E-mail, FTP (File Transfer Protocol), and so on. The method for sending images may be predetermined, or selected by Employee A. Instead of sending images, it is possible to create a folder for each attendee in the storage area of the HDD 14, and save images in the folder. After the images are saved, the attendees may read the images from their respective folders in the HDD 14.

In Step S58, when the user selects “Display” (Step S58: Display), the MFP 4 displays the images read in Step S56 on the touch panel 15. The MFP 4 displays the images in the manner designated by the user. For example, the MFP 4 displays an image over the full screen of the touch panel, or displays thumbnails of images. The MFP 4 may perform processing such as printing, saving, deleting and sending of the displayed images, according to a user instruction.

In Step S58, when the user selects “Print” (Step S58: Print), the MFP 4 prints out the images read in Step S56 (Step S62). As explained with reference to FIG. 8, each image may be printed together with other information such as file information.

In Step S58, when the user selects “Exit” (Step S58: Exit), the MFP 4 finishes the processing.

With the operations described above, the MFP 4 releases the user, such as the Employee A, from the troublesome operations of checking all the images stored in the imaging apparatus 2 one by one and choosing some of the images relating a particular event. The user simply selects the particular event information set from the schedule displayed on the GUI, and then the MFP 4 reads the images relating to the selected event information set from the imaging apparatus 2, and, for example, prints out the images.

### 3. Modifications, etc.

The present invention is described above based on the embodiments. However, the present invention is not limited to the embodiments. As a matter of course, any modifications maybe made to the present invention unless the modifications depart from the scope of the present invention.

(1) The schedule relating to the present invention does not necessarily show planned actions of the user (i.e. employee). The schedule may show any information, as long as it can be used as the conditions for selecting particular images from a large number of images. For example, the schedule may show actions actually conducted by the user.

(2) The devices of the above embodiments may be computer systems structured specifically from a microprocessor, a ROM, a RAM, a hard disk unit, a display unit, a keyboard, a mouse, etc. Computer programs are stored in the RAM or the hard disk unit. The devices achieve their functions as the microprocessor operates in accordance with the computer programs. A computer program is structured as a combination of multiple instruction codes in order for the computer to achieve predetermined functions.

Note that each device is not necessarily a computer system that includes all of the microprocessor, the ROM, the RAM, the hard disk unit, the display unit, the keyboard, the mouse, etc, and may include only some of them.

(3) The present invention may be realized as the method described above. Also, the present invention may be realized as a computer program for causing a computer to operate by the method. Also, the present invention may be realized as digital signals representing the computer program.

(4) The present invention may be any combination of the above embodiments.

(5) The embodiments and the variations above show only some aspects of the present invention to solve the problem explained in Description of the Related Art above. The following summarizes the embodiments and the variations.

One aspect of the present invention is an image data processing apparatus comprising: a first acquiring unit operable to acquire a schedule of a user; a second acquiring unit operable to acquire attributes of images from an external apparatus, the external apparatus storing therein the images and the attributes, each attribute showing a shooting condition of the corresponding image; an extracting unit operable to compare each attribute with the schedule, and extract attributes that relate to the schedule, according to the result of the comparison; a reading unit operable to read, from the external apparatus, images corresponding to the extracted attributes; and a printing unit operable to print the read images.

With the stated structure, the image data processing apparatus pertaining to the present invention is capable of reading only images captured during a particular action of the user, from among a large number of images stored in an external apparatus, and printing them. Thus, in the case of business use of the image data processing apparatus for example, the image data processing apparatus does not process the images captured during user's private actions not controlled under the user's business schedule. This prevents the image data processing apparatus from being used in private use.

The schedule may contain a plurality of event information sets each showing information of an action of the user, and the extracting unit may judge, for each attribute, whether the shooting condition thereof matches the information of any of the event information sets, and extracts the attribute when judging affirmatively, wherein the information of the action may contain at least one of (i) a date and time and (ii) a location, and the shooting condition may contain at least one of (i) a shooting date and time and (ii) a shooting location.

Alternatively, the schedule may contain a plurality of event information sets each showing a date and time relating to an action of the user, the shooting condition may contain a shooting date and time, and the extracting unit may judge, for each attribute, whether the shooting date and time thereof matches the data and time of any of the event information sets, and extracts the attribute when judging affirmatively.

With the stated structure, the image data processing apparatus is capable of narrowing down the images into those relating to the events that are under the schedule management, without user operations.

The image data processing apparatus may further comprise: a schedule displaying unit operable to output the event information sets on a display; and a selection receiving unit operable to receive, from the user, a selection instruction to select one or more of the event information sets on the display, wherein the extracting unit performs the judgment and the extraction based only on the selected event information sets.

With the stated structure, only simple operations are required for the user to narrow down the images into those relating to particular events.

The image data processing apparatus may further comprise: a print instruction receiving unit operable to receive a print instruction from the user after the selection receiving part receives the selection instruction, wherein the printing unit prints the read images on a print sheet when the print instruction receiving part receives the print instruction.

With the stated structure, the image data processing apparatus is capable of checking whether the user wishes to print out the images.

The printing unit may further print shooting conditions corresponding to the read images, together with the read images, on the print sheet.

Also, the information of the action may further contain an additional note, and the printing unit may further print additional notes corresponding to the read images, together with the read images and the shooting conditions, on the print sheet.

With the stated structure, the image data processing apparatus is capable of notifying the user of the attributes and the event information sets, relating to the captured images.

The additional note may contain at least one of (i) an event name, (ii) attendee information, and (iii) team member information.

With the stated structure, the image data processing apparatus is capable of notifying the user of at least one of the event name, the attendee information, and the team member information, relating to the captured images.

The image data processing apparatus may further comprise: a storage unit operable to store the read images, wherein the information of the action further contains an event name and at least one of attendee information and team member information, and the storage unit stores the read images classified based on the corresponding event names.

With the stated structure, in the case of storing images, the image data processing apparatus reads only the images captured for the business purpose from the external apparatus, and stores them. Thus, it is possible to avoid the possibility that a large area of the storage is occupied by images captured for the private purpose. Also, the read images are classified based on the corresponding event names and stored.

The image data processing apparatus may further comprise: a sending unit operable to send the read images, wherein the event information sets are associated one-to-one with destinations, and the sending unit sends each of the read images to the corresponding destination.

With the stated structure, the image data processing apparatus is capable of saving the user the trouble of sending the read images to their respective destinations.

The first acquiring unit may acquire the schedule from an external schedule management apparatus.

Also, the external schedule management apparatus may be a server on a network.

With the stated structure, it is possible to use the external schedule management apparatus to manage the conditions for extracting particular images from a number of images.

The external apparatus may be an imaging apparatus.

With the stated structure, the image data processing apparatus is capable of reading only images captured during a particular action of the user, from among a large number of images stored in the imaging apparatus, and printing them.

The image data processing apparatus is a multi function peripheral.

With the stated structure, the component of the image data processing apparatus that relates to printing of the images pertaining to the schedule is integrated with other components such as a component for FAX transmission. Thus, it is possible to realize centralized control of the components.

Another aspect of the present invention is a non-transitory recording medium on which an image data processing program is recorded, the image data processing program being executable by a computer used in an image data processing apparatus, the image data processing program causing the computer to execute: a first acquiring step of acquiring a schedule of a user; a second acquiring step of acquiring attributes of images from an external apparatus, the external apparatus storing therein the images and the attributes, each attribute showing a shooting condition of a corresponding one of the images; an extracting step of comparing each attribute with the schedule, and extracting attributes that relate to the schedule, according to the result of the comparison; a reading step of reading, from the external apparatus, images corresponding to attributes extracted in the extracting step; and a printing step of printing the read images.

With the stated structure, the image data processing apparatus pertaining to the present invention is capable of reading only images captured during a particular action of the user, from among a large number of images stored in an external apparatus, and printing them. Thus, in the case of business use of the image data processing apparatus for example, the image data processing apparatus does not process the images captured during user's private actions not controlled under the user's business schedule. This prevents the image data processing apparatus from being used in private use.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image data processing apparatus comprising:
a first acquiring unit operable to acquire a schedule of a user;
a second acquiring unit operable to acquire attributes of images from an external apparatus, the external apparatus storing therein the images and the attributes, each attribute showing a shooting condition of the corresponding image;
an extracting unit operable to compare each attribute with the schedule, and extract attributes that relate to the schedule, according to the result of the comparison;
a reading unit operable to read, from the external apparatus, images corresponding to the extracted attributes; and
a printing unit operable to print the read images.

2. The image data processing apparatus of claim 1, wherein
the schedule contains a plurality of event information sets each showing information of an action of the user, and
the extracting unit judges, for each attribute, whether the shooting condition thereof matches the information of any of the event information sets, and extracts the attribute when judging affirmatively, wherein
the information of the action contains at least one of (i) a date and time and (ii) a location, and
the shooting condition contains at least one of (i) a shooting date and time and (ii) a shooting location.

3. The image data processing apparatus of claim 2, further comprising:
a schedule displaying unit operable to output the event information sets on a display; and
a selection receiving unit operable to receive, from the user, a selection instruction to select one or more of the event information sets on the display, wherein
the extracting unit performs the judgment and the extraction based only on the selected event information sets.

4. The image data processing apparatus of claim 3, further comprising:
a print instruction receiving unit operable to receive a print instruction from the user after the selection receiving part receives the selection instruction, wherein
the printing unit prints the read images on a print sheet when the print instruction receiving part receives the print instruction.

5. The image data processing apparatus of claim 4, wherein
the printing unit further prints shooting conditions corresponding to the read images, together with the read images, on the print sheet.

6. The image data processing apparatus of claim 5, wherein
the information of the action further contains an additional note, and
the printing unit further prints additional notes corresponding to the read images, together with the read images and the shooting conditions, on the print sheet.

7. The image data processing apparatus of claim 6, wherein
the additional note contains at least one of (i) an event name, (ii) attendee information, and (iii) team member information.

8. The image data processing apparatus of claim 3, further comprising:
a storage unit operable to store the read images, wherein
the information of the action further contains an event name and at least one of attendee information and team member information, and
the storage unit stores the read images classified based on the corresponding event names.

9. The image data processing apparatus of claim 2, further comprising:
a sending unit operable to send the read images, wherein
the event information sets are associated one-to-one with destinations, and
the sending unit sends each of the read images to the corresponding destination.

10. The image data processing apparatus of claim 1, wherein
the schedule contains a plurality of event information sets each showing a date and time relating to an action of the user,
the shooting condition contains a shooting date and time, and
the extracting unit judges, for each attribute, whether the shooting date and time thereof matches the data and time of any of the event information sets, and extracts the attribute when judging affirmatively.

11. The image data processing apparatus of claim 1, wherein
the first acquiring unit acquires the schedule from an external schedule management apparatus.

12. The image data processing apparatus of claim 11, wherein
the external schedule management apparatus is a server on a network.

13. The image data processing apparatus of claim 1, wherein
the external apparatus is an imaging apparatus.

14. The image data processing apparatus of claim 1, wherein
the image data processing apparatus is a multi function peripheral.

15. A non-transitory recording medium on which an image data processing program is recorded, the image data processing program being executable by a computer used in an image data processing apparatus, the image data processing program causing the computer to execute:
a first acquiring step of acquiring a schedule of a user;
a second acquiring step of acquiring attributes of images from an external apparatus, the external apparatus storing therein the images and the attributes, each attribute showing a shooting condition of a corresponding one of the images;
an extracting step of comparing each attribute with the schedule, and extracting attributes that relate to the schedule, according to the result of the comparison;
a reading step of reading, from the external apparatus, images corresponding to attributes extracted in the extracting step; and
a printing step of printing the read images.
